(19) United States
(12) Patent Application Publication
(10) Pub. No.: US 2006/0146238 A1
(43) Pub. Date: Jul. 6, 2006

(54) Double-sided liquid crystal display device

(75) Inventors: Ching-Huang Lin, Miao-Li (TW); Wen-Bin Lin, Shenzhen (CN); Hong Han, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,178

(22) Filed: Dec. 23, 2005

(30) Foreign Application Priority Data
Dec. 30, 2004 (CN) 200420103606.X

(51) Int. Cl. G02F 1/1335

(52) U.S. Cl. 349/114

(57) ABSTRACT

A double-sided liquid crystal display device (20) includes a light guide plate (21) having an incident surface (211), a side surface (213), and an emitting surface (212) opposite to the side surface. A light source (22) is disposed opposite to the incident surface, and a transflective liquid crystal panel (23) is disposed adjacent to the emitting surface. The transflective liquid crystal panel enables the LCD device to achieve double-sided display via the emitting surface and the side surface respectively. Because the double-sided LCD device uses the transflective liquid crystal panel to achieve double-sided display, the double-sided LCD device can have a reduced thickness and be relatively inexpensive.

### FIELD OF THE INVENTION

The present invention relates to liquid crystal display (LCD) devices, and more particularly to an LCD device capable of double-sided displaying of images.

### GENERAL BACKGROUND

As shown in FIG. 10, a conventional double-sided liquid crystal display 10 includes a light guide plate 11. The light guide plate 11 includes an incident surface 12, and two emitting surfaces 16, 17 opposite to each other. A light source 13 is disposed opposite to the incident surface 12. Two liquid crystal modules 14, 15 are respectively disposed opposite to the emitting surfaces 16, 17. Light beams emitted from the light source 13 transmit inside the light guide plate 11 and emit out from the two emitting surfaces 16, 17, thereby illuminating the liquid crystal modules 14, 15 respectively.

However, in order to achieve double-sided display, the double-sided liquid crystal display 10 needs two liquid crystal modules 14, 15. This increases a thickness of the double-sided liquid crystal display 10, and increases costs.

What is needed, therefore, is a liquid crystal display device that overcomes the above-described deficiencies.

### SUMMARY

In a preferred embodiment, a double-sided liquid crystal display (LCD) device includes a light guide plate having an incident surface, a side surface, and an emitting surface opposite to the side surface. A light source is disposed opposite to the incident surface, and a transflective liquid crystal panel is disposed adjacent to the emitting surface. The transflective liquid crystal panel enables the LCD device to achieve double-sided display via the emitting surface and the side surface respectively.

Because the double-sided LCD device uses the transflective liquid crystal panel to achieve double-sided display, the double-sided LCD device can have a reduced thickness and be relatively inexpensive.

Other advantages and novel features will become more apparent from the following detailed description when taken in conjunction with the accompanying drawings.

### BRIEF DESCRIPTION OF THE DRAWINGS

FIG. 1 is a schematic, exploded, side view of a double-sided LCD device according to a first embodiment of the present invention, showing essential light paths thereof.

FIG. 2 is a schematic, exploded, isometric view of a double-sided LCD device according to a second embodiment of the present invention.

FIG. 3 is a schematic, isometric view of a light guide plate employed in a double-sided LCD device according to a third embodiment of the present invention.

FIG. 4 is a schematic, isometric view of a light guide plate employed in a double-sided LCD device according to a fourth embodiment of the present invention.

FIG. 5 is a schematic, isometric view of a light guide plate employed in a double-sided LCD device according to a fifth embodiment of the present invention.

FIG. 6 is a schematic, isometric view of a light guide plate employed in a double-sided LCD device according to a sixth embodiment of the present invention.

FIG. 7 is a schematic, isometric view of a light guide plate employed in a double-sided LCD device according to a seventh embodiment of the present invention.

FIG. 8 is a schematic, exploded, isometric view of a double-sided LCD device according to an eighth embodiment of the present invention.

FIG. 9 is a schematic, exploded, side cross-sectional view of a double-sided LCD device according to a ninth embodiment of the present invention.

FIG. 10 is a schematic, exploded, side view of a conventional double-sided LCD device.

### DETAILED DESCRIPTION OF PREFERRED EMBODIMENTS

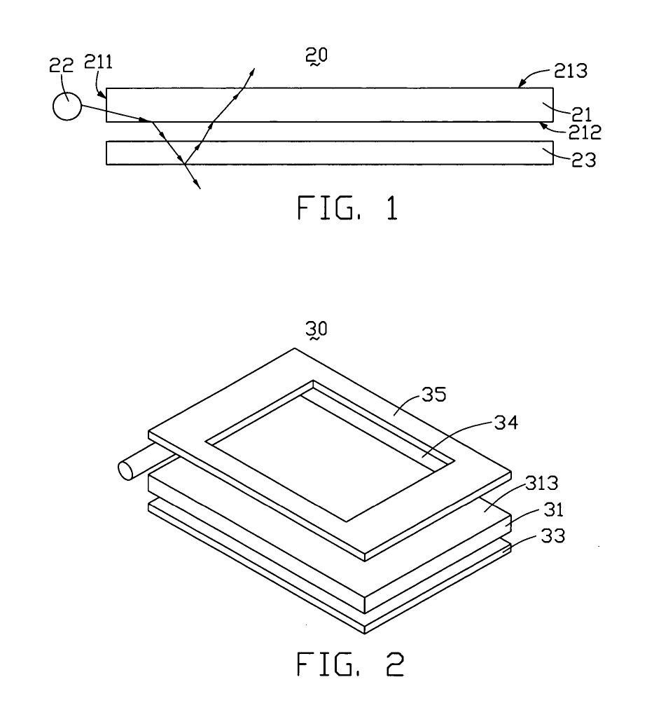

FIG. 1 is a schematic, side view of a double-sided LCD device 20 according to a first embodiment of the present invention. The double-sided LCD device 20 includes a light guide plate 21 having an incident surface 211, an emitting surface 212, and a side surface 213 opposite to the emitting surface 212. A light source 22 is disposed opposite to the incident surface 211, and a transflective liquid crystal panel 23 is disposed adjacent the emitting surface 212.

The transflective liquid crystal panel 23 enables the double-sided LCD device 20 to achieve double-sided display. In use, light beams emitted from the light source 22 enter the light guide plate 21 from the incident surface 211. A portion of the light beams emits from the transflective liquid crystal panel 23 to display images. Another portion of the light beams is reflected by the transflective liquid crystal panel 23 and then emits from the side surface 213 to display images. In the exemplary embodiment, when the images are viewed from the transflective liquid crystal panel 23, the images appear as normal images. However, when the images are viewed from the side surface 213, the images are reversed relative to the normal images. That is, left and right sides seen in the normal images are seen as right and left sides in the reversed images.

In summary, the double-sided LCD device 20 uses the transflective liquid crystal panel 23 to achieve double-sided display. This can decrease a thickness of the double-sided LCD device 20, and can decrease costs.

FIG. 2 is a schematic, isometric view of a double-sided LCD device 30 according to a second embodiment of the present invention. The double-sided LCD device 30 is similar to the double-sided LCD device 20 of FIG. 1. However, the double-sided LCD device 30 includes a light guide plate 31, and further includes a reflective plate 35 disposed opposite to a side surface 313. The reflective plate 35 includes a window 34 for display. A size of the window 34 can be configured to be different from a size of a transflective liquid crystal panel 33. The reflective plate 35 can reflect light beams emitted from a periphery of the side surface 313 back into the light guide plate 31. Such light beams are thus re-used, which can improve the overall utilization of light beams.

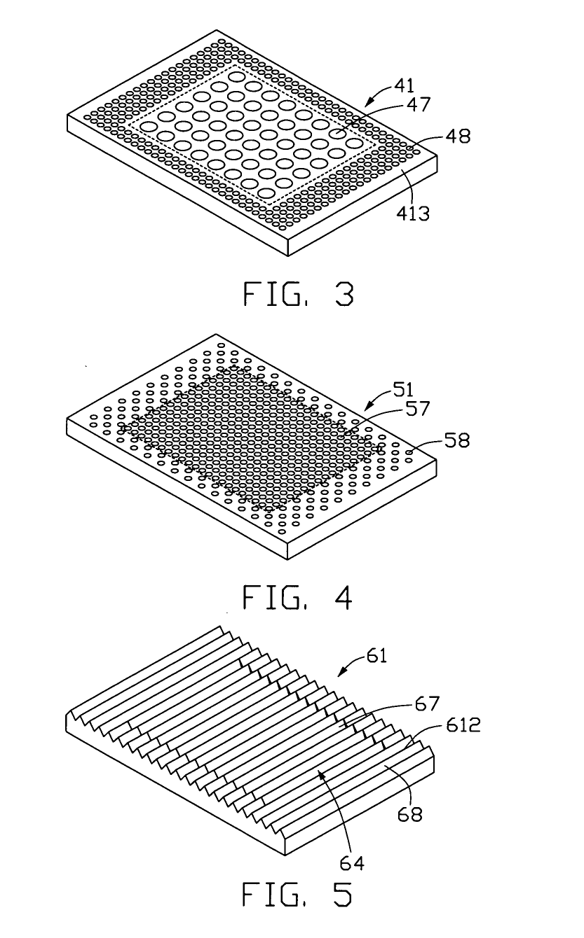

FIG. 3 is a schematic, isometric view of a light guide plate employed in a double-sided LCD device according to a third embodiment of the present invention. The light guide plate 41 is similar to the light guide plate 31 of FIG. 2. However, a first pattern of diffusion dots 47 and a second pattern of diffusion dots 48 are provided at the side surface 413. The first pattern 47 is disposed in a central region of the side surface 413 which corresponds to a window of an associated reflective plate. The second pattern 48 surrounds the first pattern 47. A diameter of each of diffusion dots of the first pattern 47 is larger than a diameter of each of diffusion dots of the second pattern 48. Each of the diffusion dots can be in the form of a protrusion or a concavity.

FIG. 4 is a schematic, isometric view of a light guide plate employed in a double-sided LCD device according to a fourth embodiment of the present invention. The light guide plate 51 is similar to the light guide plate 41 of FIG. 3. However, the light guide plate 51 comprises a first pattern of diffusion dots 57 and a second pattern of diffusion dots 58. The diffusion dots all have a same diameter. A density of the diffusion dots of the first pattern 57 is greater than a density of the diffusion dots of the second pattern 58.

FIG. 5 is a schematic, isometric view of a light guide plate employed in a double-sided LCD device according to a fifth embodiment of the present invention. The light guide plate 61 is similar to the light guide plate 31 of FIG. 2. However, a plurality of parallel first V-shaped grooves 67 and a plurality of parallel second V-shaped grooves 68 are disposed at an emitting surface 612. The first V-shaped grooves 67 are disposed in a central region 64 of the emitting surface 612 which corresponds to a window of an associated reflective plate. The second V-shaped grooves 68 surround the first V-shaped grooves 67. A depth of the first V-shaped grooves 67 is greater than a depth of the second V-shaped grooves 68.

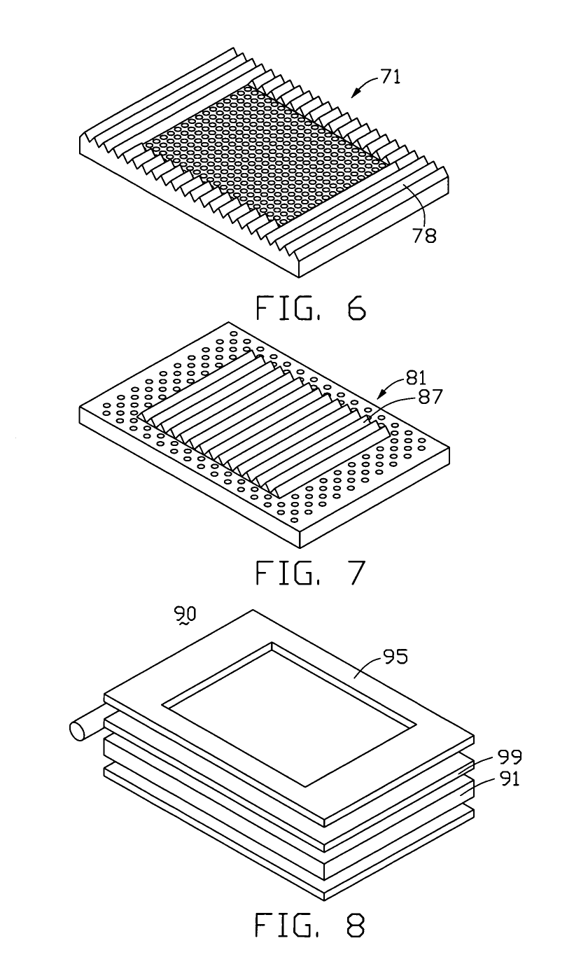

FIG. 6 is a schematic, isometric view of a light guide plate employed in a double-sided LCD device according to a sixth embodiment of the present invention. The light guide plate 71 is similar to the light guide plate 51 of FIG. 4. However, instead of having the second pattern 58, the light guide plate 71 has a plurality of parallel V-shaped grooves 78.

FIG. 7 is a schematic, isometric view of a light guide plate employed in a double-sided LCD device according to a seventh embodiment of the present invention. The light guide plate 81 is similar to the light guide plate 51 of FIG. 4. However, instead of having the first pattern 57, the light guide plate 81 has a plurality of parallel V-shaped grooves 87.

FIG. 8 is a schematic, exploded, isometric view of a light guide plate employed in a double-sided LCD device according to an eighth embodiment of the present invention. The double-sided LCD device 90 is similar to the double-sided LCD device 30 of FIG. 2. However, the double-sided LCD device 90 further includes a diffusion plate 99 between a light guide plate 91 and a reflective plate 95.

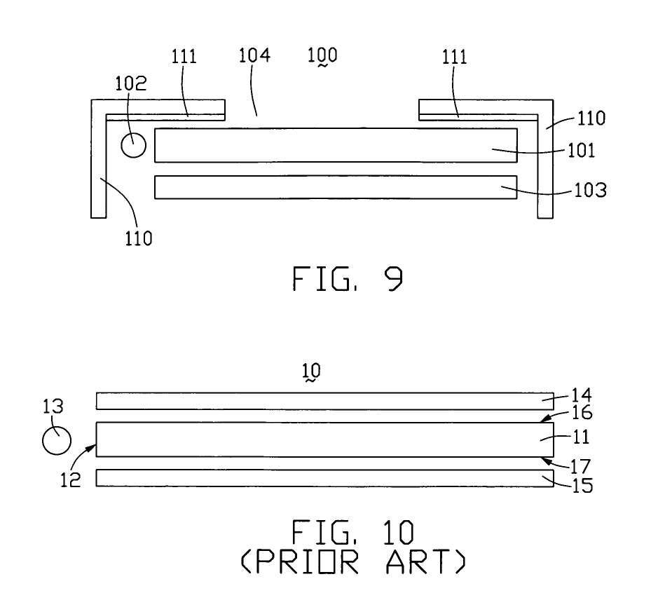

FIG. 9 is a schematic, exploded, side cross-sectional view of a double-sided LCD device according to a ninth embodiment of the present invention. The double-sided LCD device 100 is similar to the double-sided LCD device 30 of FIG. 2. However, the double-sided LCD device 100 further includes a frame 110 to protect a light guide plate 101, a light source 102, and a transflective liquid crystal panel 103. The frame 110 includes a central opening 104. A reflective layer 111 is disposed at an inner surface of the frame 110 opposite to the light guide plate 101.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A double-sided liquid crystal display device, comprising:
a light guide plate having an incident surface, a side surface, and an emitting surface opposite to the side surface;
a light source disposed opposite the incident surface; and
a transflective liquid crystal panel disposed adjacent to the emitting surface, providing double-sided display via the emitting surface and the side surface respectively.

2. The double-sided liquid crystal display device as claimed in claim 1, further comprising a reflective plate disposed opposite to the side surface, wherein the reflective plate defines a window for enabling display.

3. The double-sided liquid crystal display device as claimed in claim 2, wherein the light guide plate further comprises a first pattern of diffusion structures and a second pattern of diffusion structures provided at the side surface, the first pattern is located in a region opposite to the window, and the second pattern is located in a region surrounding the first pattern.

4. The double-sided liquid crystal display device as claimed in claim 3, wherein the diffusion structures are diffusion dots, and a diameter of the diffusion dots of the first pattern is larger than a diameter of the diffusion dots of the second pattern.

5. The double-sided liquid crystal display device as claimed in claim 3, wherein a density of the diffusion dots of the first pattern is greater than a density of the diffusion dots of the second pattern.

6. The double-sided liquid crystal display device as claimed in claim 3, wherein the diffusion structures of the first pattern are V-shaped grooves, and the diffusion structures of the second pattern are diffusion dots.

7. The double-sided liquid crystal display device as claimed in claim 3, wherein the diffusion structures of the first pattern are diffusion dots, and the diffusion structures of the second pattern are V-shaped grooves.

8. The double-sided liquid crystal display device as claimed in claim 2, further comprising a diffusion plate between the light guide plate and the reflective plate.

9. The double-sided liquid crystal display device as claimed in claim 2, further comprising a frame to protect the light guide plate, the light source, and the transflective liquid crystal panel.

10. The double-sided liquid crystal display device as claimed in claim 9, wherein the frame defines an open opposite to the window.

11. The double-sided liquid crystal display device as claimed in claim 10, wherein the frame comprises a reflective layer at an inner surface thereof opposite to the light guide plate.
